(19) United States
(12) Patent Application Publication
(10) Pub. No.: US 2023/0286666 A1
(43) Pub. Date: Sep. 14, 2023

(54) IN-FLIGHT DRONE STRUCTURE MODIFICATION

(71) Applicant: INTERNATIONAL BUSINESS MACHINES CORPORATION, ARMONK, NY (US)

(72) Inventors: Clement Decrop, Arlington, VA (US); Shikhar Kwatra, San Jose, CA (US); Saurabh Yadav, Bangalore (IN); Vijay Ekambaram, Chennai (IN)

(21) Appl. No.: 17/653,948

(22) Filed: Mar. 8, 2022

(51) Int. Cl. B64D 31/10; B64C 39/02; B64D 17/80; B64D 1/02; B64D 45/00; G05D 1/10

(52) U.S. Cl. CPC B64D 31/10; B64C 39/024; B64D 17/80; B64D 1/02; B64D 45/00; G05D 1/101; B64C 2201/027; B64C 2201/108

(57) ABSTRACT

A method, computer system, and a drone for in-flight drone structure modification are provided. A first sensor of a drone may detect damage to a first arm of the drone during a flight of the drone. In response to the detecting the damage, the damaged first arm of the drone may be detached via a computer of the drone and during the flight of the drone.

### BACKGROUND

The present invention relates generally to the field of aerial drones. An aerial drone is an unmanned aircraft and may sometimes be referred to as an unmanned aerial vehicle. An aerial drone is capable of being piloted and flying without an on-board human pilot. An aerial drone may be controlled using an on-board computer and pre-programmed instructions such that the drone operates autonomously. An aerial drone may alternatively or additionally as a remotely piloted aircraft be piloted by a human who controls the drone but who is positioned remotely from the drone.

### SUMMARY

According to one exemplary embodiment, a method for mid-flight drone modification is provided. A first sensor of a drone detects damage to a first arm of the drone during a flight of the drone. In response to the detecting the damage, during the flight of the drone a computer of the drone detaches the damaged first arm of the drone. A drone configured to achieve the mid-flight drone modification is also described herein. A computer system and a drone configured to help achieve the method described above are also described herein.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer and drone environment according to at least one embodiment;

FIG. 2 illustrates some aspects of a drone according to at least one embodiment;

FIG. 3 illustrates some internal and communication-related aspects of components of a drone according to at least one embodiment;

FIG. 4A illustrates some aspects of a drone according to at least one other embodiment;

FIG. 4B illustrates some aspects of a drone according to at least one other embodiment;

FIG. 5 is an operational flowchart illustrating an in-flight drone structure modification process according to at least one embodiment;

FIG. 6 is a block diagram of internal and external components of computers, drone computers, phones, and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Drones are used for many different purposes such as package delivery, image and/or video capture, film-making, agricultural oversight and planning, city ordinance enforcement, other government functions, and as components of communication networks. Drones that are aerial drones may be multi-rotary drones which have multiple motors and are able to supply power and/or current to each of the rotors. In some instances, a separate motor or power source may be present for each rotor. Drones are useful because they can take off and land in the same place without needing a runway to take off and land. At least some embodiments of drones are able to take off, fly, and land without direct pilot control. At least some drones according to the present embodiments have multiple flexible and adjustable arms which help a drone withstand wind during flight. The drones of the present embodiments may include automatic folding arms configured to make in-flight adjustments. In at least some embodiments the drones may be designed after insect wings. Unfortunately, however, having multiple arms of any sort also increases the chance of one or more arms being damaged during flight.

The following described exemplary embodiments provide a method and drone for minimizing drone crash possibility when a drone sustains arm or wing damage during a drone flight. When one or more wings or arms of a drone are impacted by an accident and sustain damage, in some instances other wings or arms of the drone may have sufficient strength and drone control capabilities to allow the drone to finish its intended flight and/or to safely land instead of crashing. The damaged arm or arms may nevertheless be a hindrance for the remaining flight. Detaching or removing the damaged wing and modifying the remaining wings may increase the likelihood of avoiding a crash and safely landing, e.g., as part of an emergency landing. A modification to the remaining wings may include realignment of those wings. The so-modified drone may have a reduced strength, power, and maneuverability compared to an original strength, power, and maneuverability that it had when all arms were functioning well, but the so-modified drone may still have sufficient strength, flight power, and maneuverability to complete the intended flight and/or to make a safe emergency landing.

Some embodiments of drones are multi-rotary drones with multiple rotors that usually rotate in a plane parallel to a flat ground surface. A drone may, for example, be a quadcopter, an octocopter, a hex-copter, or other multicopter depending on the number of rotors that are connected to the drone main body and that via spinning and rotating provide power to the drone for movement.

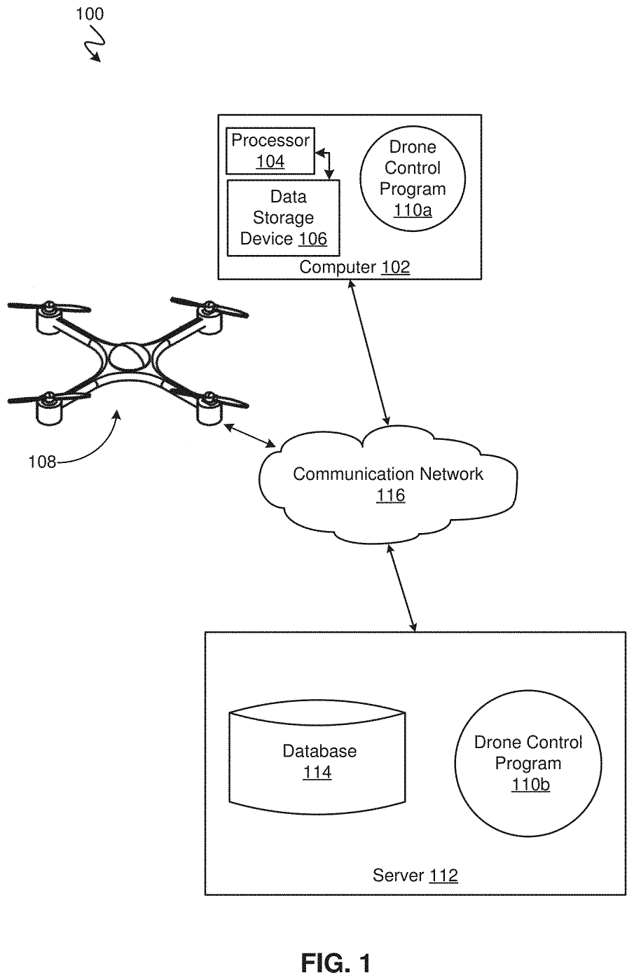

Referring to FIG. 1, an exemplary networked drone computer environment 100 in accordance with one embodiment is depicted. The networked drone computer environment 100 may include a computer 102 with a processor 104 and a data storage device 106 that is enabled to run a drone control program 110a. The networked drone computer environment 100 may also include a server 112 that is a computer and that is enabled to run a drone control program 110b that may interact with a database 114 and a communication network 116. The networked drone computer environment 100 may also include a first drone 108 that may fly and has a computer enabled to run a further drone control program. The networked drone computer environment 100 may include a plurality of computers 102, servers 112, and drones 108 although only one computer 102, one server 112, and one first drone 108 are shown in FIG. 1. In some embodiments, a user may be using the computer 102 to control some aspects of the first drone 108 and its flight via control messages being input via the user into the computer 102 and transmitted via the communication network 116 to the first drone 108. The communication network 116 allowing communication between the computer 102, the server 112, and/or the first drone 108 may include various types of communication networks, such as the Internet, a wide area network (WAN), a local area network (LAN), a telecommunication network, a wireless network, a public switched telephone network (PTSN) and/or a satellite network. The first drone 108 may communicate with the computer 102 via Wi-Fi signals and/or via radio frequency signals that may constitute or be part of the communication network 116. The first drone 108 may communicate with the server 112 via Wi-Fi signals and/or via radio frequency signals that may constitute or be part of the communication network 116.

It should be appreciated that FIG. 1 provides only an illustration of one implementation and does not imply any limitations with regard to the environments in which different embodiments may be implemented. Many modifications to the depicted environments may be made based on design and implementation requirements.

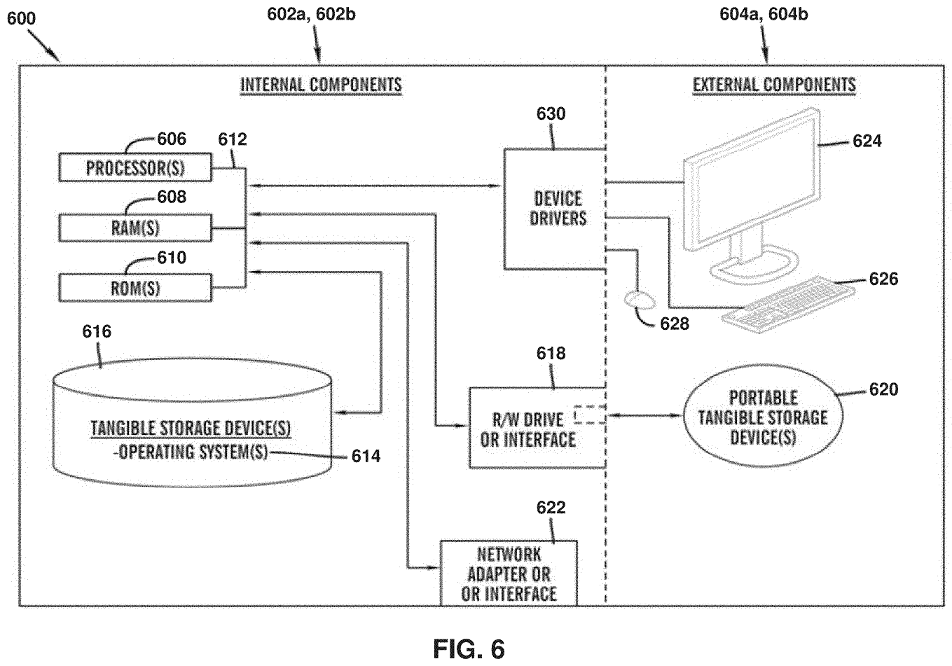

The client computer 102 may communicate with the server 112 via the communication network 116. The communication network 116 may include connections, such as wire, wireless communication links, or fiber optic cables. As will be discussed with reference to FIG. 6, server 112 may include internal components 602a and external components 604a, respectively, and client computer 102 may include internal components 602b and external components 604b, respectively. An on-board computer of the first drone 108 may also include its own set of internal components 602b and external components 604b. Server 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114 in a server 112 that is remotely located with respect to the client computer 102. The client computer 102 may be mobile and may include a display screen and a camera. According to various implementations of the present embodiment, the drone control program 110a, 110b and a further drone control program in an on-board computer of the first drone 108 may interact with a database 114 that may be embedded in various storage devices, such as, but not limited to a computer/mobile device 102, a networked server 112, or a cloud storage service.

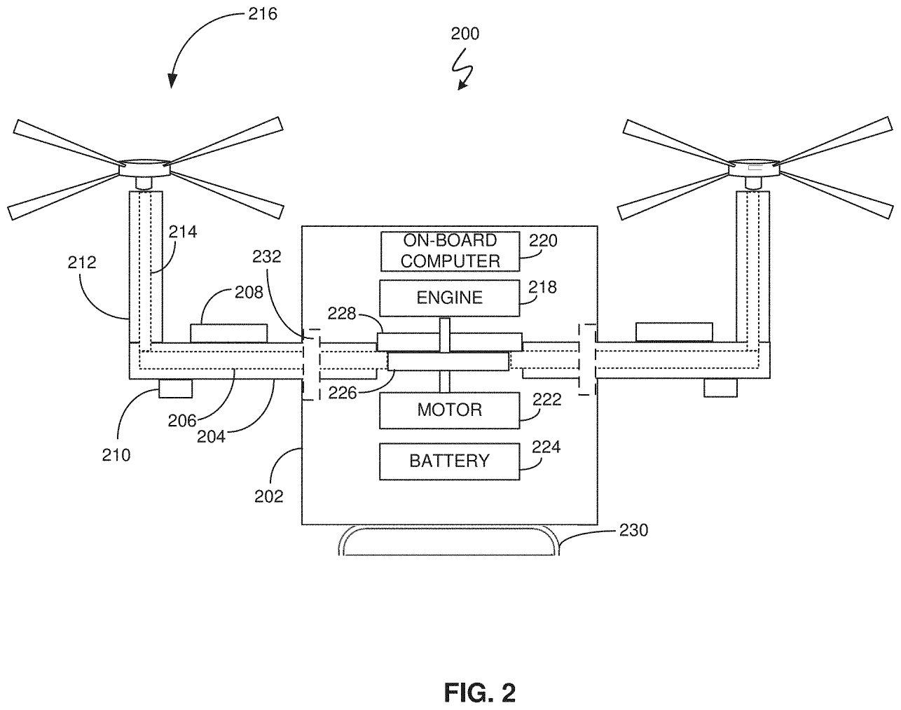

According to the present embodiment, a user using a client computer 102 may use the drone control program 110a, 110b and a further drone control program in a drone to control or manage some aspects of the flight of a drone such as the first drone 108. An in-flight drone structure modification process is explained in more detail below with respect to FIGS. 2-5.

FIG. 2 illustrates some aspects of a drone according to at least one embodiment. FIG. 2 shows a second drone 200 which is configured for arm detachment in the event that that the arm or the rotor attached to the arm receives debilitating damage during a flight. The second drone 200 includes multiple propellers or rotors which are distributed around the second drone 200. A first rotor 216 is labeled with a reference number in FIG. 2. A support arm 204 and a support beam 212 connected to the support arm 204 provide support to carry the first rotor 216 and to keep the first rotor 216 attached to the drone main body 202. The support arm 204 extends through an opening in an outer wall of the drone main body 202 and into an interior of the drone main body 202. The support arm 204 and the support beam 212 may together along with the first rotor 216 constitute a first arm of the second drone 200.

Inside or connected to the drone main body 202 are various components of the second drone 200. A drone on-board computer 220 is disposed within the drone main body 202 and includes computer components which help control operations of the second drone 200. The drone on-board computer may have a further drone control program saved thereon. Some examples of components of the drone on-board computer 220 are shown in FIG. 6. The drone main body 202 may also include an engine 218, a motor 222, and/or a battery 224 which may provide power to drive and rotate the various rotors such as the first rotor 216. The engine 218 may be an internal combustion engine. The motor 222 may be an electric motor. In some embodiments, each rotor and arm combination of the second drone 200 may have its own respective power source such as a respective engine 218, motor 22, and/or battery 224 for power to be driven, e.g., rotated. All or some of these power components may have a power transmission connection to a geared transmission 226 for transmitting power to the rotor such as the first rotor 216. The geared transmission 226 may actuate a power transfer extension 206 and a driveshaft 214 to provide power to rotate the first rotor 216. The power transfer extension 206 may in some embodiments be a chain or a primary driveshaft.

Detachment structure for facilitating mid-flight detachment of the arm if the arm becomes damaged may include a fastener 232 and a cam 228. A fastener 232 connected to a wall, e.g., an outer wall, of the drone main body 202, may during normal operation extend through an opening in the support arm 204 or against the support arm 204 to help the secure the support arm 204 to the drone main body 202 during flight. In FIG. 2, the fastener 232 is shown as extending through an opening in the support arm 204. If the drone on-board computer 220 gives a signal to the detachment structure to detach the arm due to damage to the arm, the power components may cause a movement of the fastener 232 so that the fastener 232 is expelled from the opening of the support arm 204 or moves away from a support position. The fastener 232 may be linearly translated along a track attached to the wall of the drone main body 202. The signal from the drone on-board computer 220 may cause an actuator connected to the fastener 232 to move the fastener 232, e.g., to move the fastener along the track. The signal may send power to the actuator. Alternatively, the actuator may have its own power source. A further signal may be sent by the drone on-board computer 220 to the power components to cause a rotation of the cam 228 which causes a portion of the cam 228 to push against the support arm 204 and translationally move the support arm 204 away from the drone main body 202. In the embodiment shown in FIG. 2 the cam 228 may push the support arm 204 outwards from the opening in the drone main body 202. This cam rotation may occur after or simultaneously with the fastener 232 being removed. With the fastener 232 no longer being engaged with the support arm 204, the force from the cam 228 may push the support arm 204 out of the drone main body 202. Then the weight of this arm, e.g., the first rotor 216, the support arm 204, and the support beam 212, may cause the arm to fall downward and be detached from the drone main body 202. Any physical control lines running through the respective arm, e.g., from one of the power components or from the drone on-board computer 220, may also be severed as part of the detachment.

FIG. 2 also shows a parachute 208 attached to this arm. As will be explained subsequently, this parachute 208 may be deployed after detachment of the arm to allow a safe landing for the detached arm and to reduce a falling speed of the detached arm. An arm computer and sensors on the arm may be used to help control deployment of the parachute 208 at an appropriate time after detachment of the arm. The parachute 208 may be attached to some portion of the detached arm such as the support arm 204. At least some embodiments of the drone of the present embodiments may include parachutes attached to the arms, respectively, of the drone.

FIG. 2 also shows a satellite navigational signal responder/transmitter 210 which may transmit a satellite navigational signal which may allow the falling detached arm to be tracked and eventually located and recovered. The satellite navigational signal responder/transmitter 210 may be attached to some portion of the detached arm such as the support arm 204.

FIG. 2 also shows a payload harness 230 which may allow the second drone 200 to secure and deliver goods via the flight. The payload harness 230 may be connected to the drone main body 202, e.g., in a central location underneath the drone main body 202. The payload harness 230 may also be movable in its position with respect to the drone main body 202 based on control instructions received from the drone on-board computer 220. The payload harness 230 may in some embodiments move along a track to change a position from being underneath the drone main body 202 to being disposed on a lateral side or an upper side or in an interior of the drone main body 202.

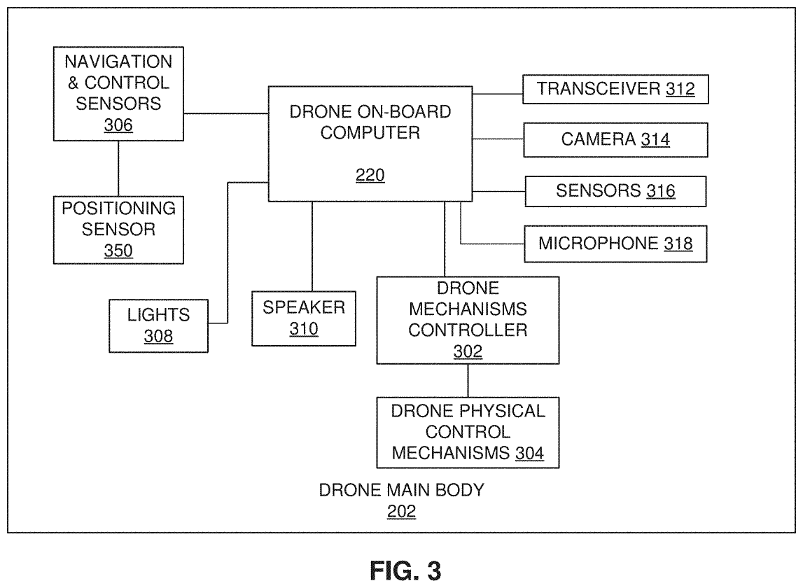

FIG. 3 illustrates some internal and communication-related aspects of components of a drone according to at least one embodiment. FIG. 3 shows a drone on-board computer 220 that controls a drone mechanisms controller 302. The drone mechanisms controller 302 is another computer that controls a set of drone physical control mechanisms 304. The set of drone physical control mechanisms 304 includes, but is not limited to, throttles for the engine 218 and/or motor 222, selectors for selecting gear ratios within the geared transmission 226, controls for adjusting the pitch, roll, and angle of attack of the rotors such as the first rotor 216, the arm detachment structure, and other controls used to control the operation and movement of the second drone 200 depicted in FIG. 2. The set of drone physical controls mechanisms 304 may include arm detachment structure such as the cam 228 and the fastener 232 that were described with respect to FIG. 2.

Whether in autonomous mode or remotely-piloted mode, the drone on-board computer 220 controls the operation of the second drone 200. This control includes the use of outputs, e.g., sensed data, from navigation and control sensors 306 to control the second drone 200. Navigation and control sensors 306 may include hardware sensors that (1) determine the location of the second drone 200; (2) sense other aerial drones and/or obstacles and/or physical structures around the second drone 200; (3) measure the speed and direction of the second drone 200; and (4) provide any other inputs needed to safely control the movement of the second drone 200. Specific examples of the navigation and control sensors 306 will be described subsequently and may be used to check rotor/arm health and to ascertain damage to the rotors and/or arms.

A positioning system may be part of the drone on-board computer 220 and may also include the positioning sensor 350. The positioning system may use a global satellite navigational signal, such as a GPS signal, which uses space-based satellites that provide positioning signals that are triangulated by a GPS receiver to determine a 3-D geophysical position of the second drone 200. The positioning system may also use, either alone or in conjunction with a satellite navigational system, physical movement sensors such as accelerometers (which measure changes in direction and/or speed by an aerial drone in any direction in any of three dimensions), speedometers (which measure the instantaneous speed of an aerial drone), air-flow meters (which measure the flow of air around an aerial drone), barometers (which measure altitude changes of the aerial drone), etc. Such physical movement sensors may incorporate the use of semiconductor strain gauges, electromechanical gauges that take readings from drivetrain rotations, barometric sensors, etc.

The drone on-board computer 220 may utilize radar or other electromagnetic energy that is emitted from an electromagnetic radiation transmitter (e.g., from the transceiver 312 shown in FIG. 3), bounced off a physical structure (e.g., a building, bridge, or another aerial drone), and then received by an electromagnetic radiation receiver (e.g., the transceiver 312) in order to sense other aerial drones and/or obstacles and/or physical structures around the second drone 200. By measuring the time it takes to receive back the emitted electromagnetic radiation, and/or evaluating a Doppler shift (i.e., a change in frequency to the electromagnetic radiation that is caused by the relative movement of the second drone 200 to objects being interrogated by the electromagnetic radiation) in the received electromagnetic radiation from when it was transmitted, the presence and location of other physical objects in the physical environment of the second drone 200 can be ascertained by the drone on-board computer 220.

The transceiver 312 may additionally be configured to transmit and/or receive signals from other computers such as the computer 102 to trade data and to receive control instructions from a user such as a remote pilot operating the computer 102. The user of the computer 102 may use the drone control program 110a stored in the computer 102 to send data to, receive data from, and control the flight of the drone.

An on-board airspeed indicator of the second drone 200 may measure speed of flight of the second drone 200. Movements of the control mechanisms on the second drone 200 may also be measured and analyzed. The positioning system may also help determine a speed of movement of the second drone 200. These tools and/or sensors may be used to determine the speed and direction of the flight of the second drone 200.

The second drone 200 may in one or more embodiments include a camera 314 which is capable of sending still or moving visible light digital photographic images (and/or infrared light digital photographic images) to the drone on-board computer 220. These images can be used to determine the location of the second drone 200 (e.g., by matching the captured images to known landmarks), to sense other drones/obstacles, and/or to determine speed (by tracking changes to images as the drone moves and passes by other objects) of the aerial drone.

The second drone 200 may in one or more embodiments include sensors 316. Examples of sensors 316 include air pressure gauges, barometers, chemical sensors, vibration sensors, etc., which detect a real-time operational condition of second drone 200 including a rotor/arm health and/or an environment around second drone 200. One or more microphones 318 may also be present with the second drone 200 to capture audio sound of the operation of the second drone 200. Another example of a sensor from sensors 316 is a light sensor which is able to detect light from other drones, streetlights, home lights, etc., in order to ascertain the environment in which the second drone 200 is operating.

Also on second drone 200 in one or more embodiments are lights 308. Lights 308 may be activated by the drone on-board computer 220 to provide visual warnings, alerts, etc.

Also on second drone 200 in one or more embodiments is a speaker 310. Speaker 310 may be used by the drone on-board computer 220 to provide audio warnings, alerts, etc.

Also on second drone 200 in one or more embodiments is a microphone 318. In an embodiment, microphone 318 is an omnidirectional sensor that measures ambient noise (e.g., sound produced by the second drone 200). In the same or another embodiment, microphone 318 is a directional microphone (e.g., that captures sounds at some distance away from the second drone 200).

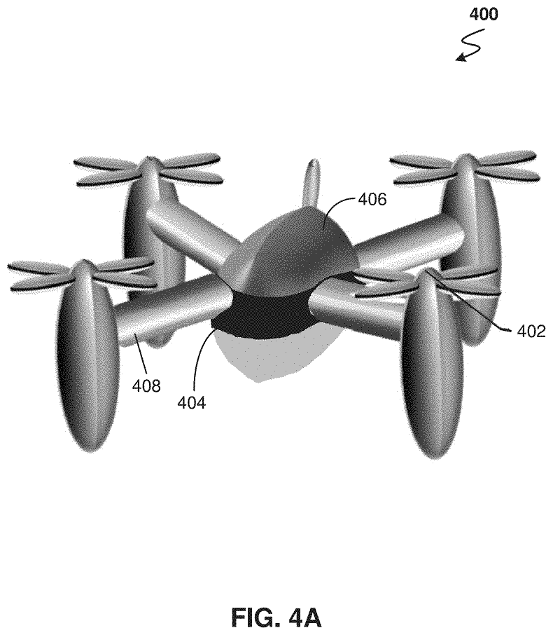

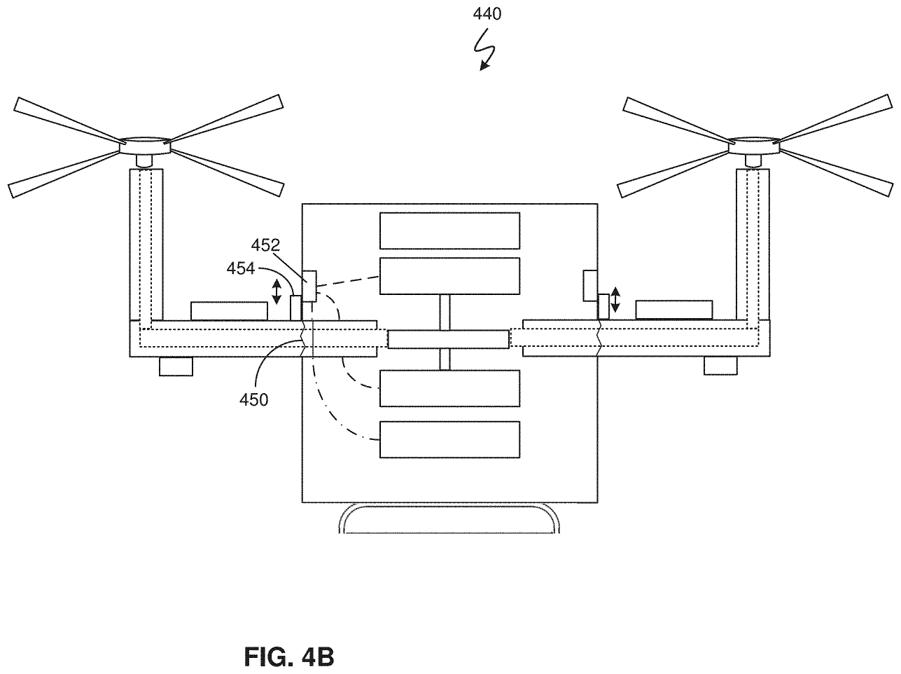

The drone on-board computer 220 may also control the arm detachment structures, e.g., the arm detachment structures that were described above with respect to FIG. 2 or those that are described subsequently with respect to FIG. 4B. The drone on-board computer 220 may also control arm realignment structure as is described subsequently with respect to FIG. 4A. The drone on-board computer 220 may also control positioning of payload holding structure, e.g., of the payload harness 230 shown in FIG. 2.

FIG. 4A illustrates some aspects of a drone according to at least one other embodiment. FIG. 4A illustrates an arm track 404 which allows rotational movement of various arms of a third drone 400 around a periphery of the third drone 400. The arm track 404 may be implemented in other embodiments shown such as the first drone 108, the second drone 200, and the fourth drone 440 that is depicted in FIG. 4B. The arms of the third drone 400 may be detached from the third drone main body 406 using arm detachment structures such as are described for the embodiments of FIGS. 2 and 4b. A third drone support arm 408 is shown as being engaged in the arm track 404 so as to be rotatable around the periphery of the third drone 400. A third drone rotor 402 is also labeled in FIG. 4.

If the sensors of the third drone 400 indicate that one of the drone arms is damaged and malfunctioning and if that arm is, in response, detached or retracted, the remaining arms of the third drone 400 may be moved around the arm track 404 to adjust their positions to compensate for loss of the detached arm. For example, remaining arms may be moved around the arm track 404 to find a new equidistance from neighboring arms/rotors and so that a gap in rotor/arm positioning due to the arm detachment is filled.

FIG. 4B illustrates some aspects of a drone according to at least one other embodiment, specifically of a fourth drone 440. This fourth drone 440 includes many similar structures as the second drone 200 that was depicted in FIG. 2. The fourth drone 440 includes, however, at least some alternative arm detachment structure. Specifically, the alternative arm detachment structure includes a pre-planned breakage point 450 in the support arm. This pre-planned breakage point 450 may be aligned at an outer wall of the drone main body so that when substantial arm damage is sensed the arm may be detached. This pre-planned breakage point 450 may include a weakened portion of the material of the support arm. For example, the pre-planned breakage point 450 may include some holes distributed intermittently in the material of the support arm. An actuator 452 attached to the fourth drone main body may receive power from one of the power sources of the fourth drone 440 to actuate a ram 454 which may in one instance or repeatedly strike the exterior of the support arm in a region at, near, or distant from the pre-planned breakage point 450. This striking, e.g., striking at the region adjacent to the pre-planned breakage point 450, may cause the support arm to break at the pre-planned breakage point 450 and then be detached from the rest of the fourth drone 440 due to its falling weight and due to the corresponding rotor losing power after breakage. A fourth drone on-board computer analogous to other computers described herein may analyze sensor data to determine if the flight would be better if a damaged arm is detached. Upon making this determination that detachment would be helpful, the fourth drone on-board computer may send one or more signals to the power sources and/or to the actuator 452 to cause the arm detachment to commence. Each arm of the fourth drone 440 may include an equivalent or similar pre-planned breakage point and a respective ram for causing breakage at the pre-planned breakage point.

Explosives may also be planted in the arm and detonated based on control signals from the drone on-board computer 220 when arm detachment is recommended by the drone control program on the drone on-board computer 220. The explosives may in some embodiments be followed by the actuating ram to cause detachment of the arm. The explosives may be strong enough to separate the arm but small enough to avoid inflicting additional damage to the drone main body.

In alternative embodiments, instead of or in addition to the ram 454 a drone may have material separators near a breakage point such as the pre-planned breakage point 450. The material separators may be mounted to the main drone body to be moveable to engage at the pre-planned breakage point 450. For example, an angle grinder with an abrasive metal-cutting disc may be disposed adjacent the drone arm and/or adjacent to the pre-planned breakage point 450. For example actuation of a slide or pivot may move the angle grinder into the path of the pre-planned breakage point 450, the disc may be actuated, and with rotation of the disc the disc may cut through the arm, e.g., at the pre-planned breakage point 450. A circular saw, reciprocating saw, and/or an oscillating tool with steel-tooth blades, diamond blades, and/or carbide-tooth blades may be used similarly to the angle grinder.

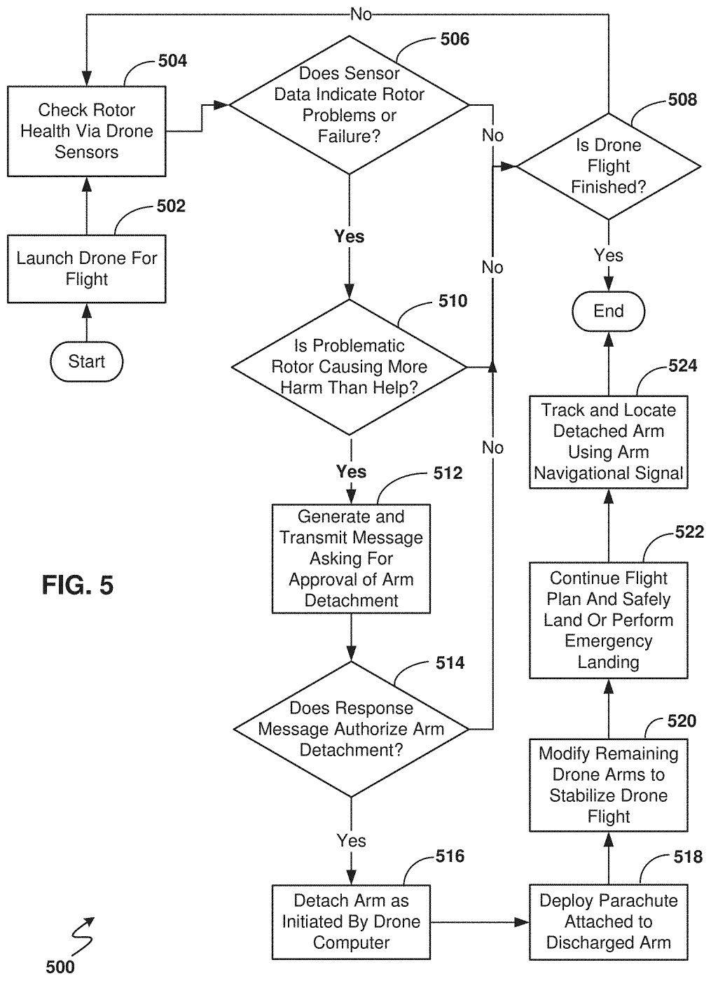

Referring now to FIG. 5, an operational flowchart depicts an in-flight drone structure modification process 500 that may, according to at least one embodiment, be performed by components of a drone such as the first drone 108, the second drone 200, the third drone 400, the fourth drone 440, by the drone control program 110a, 110b, and/or by a further drone control program that is disposed on-board an in-flight drone such as the first drone 108 and that is disposed on the on-board drone computer 220.

In a step 502 of the in-flight drone structure modification process 500, a drone is launched for flight. For a rotary drone, e.g., a multi-rotary drone, which has one or more rotors disposed parallel to the ground, one or more motors of the drone may cause the rotors to spin in the same direction. This spinning produces a lifting force which may lift the entire drone off of the ground and into the air. In other embodiments, additional horizontal force may also assist with the drone launching. A visual and/or mechanical evaluation of the drone and its arms and rotors may often be undertaken by a drone technician before the drone launches.

In flight and/or during takeoff or during a landing, a drone may experience a collision which may cause damage to one or more arms of the drone. This damage may cause one arm to be a hindrance to further successful flying or landing.

In a step 504 of the in-flight drone structure modification process 500, rotor health is checked via drone sensors. This check may be for rotors of the drone that was launched in step 502. The performance of the rotors of the drone that has launched and is in a flight may indicate the likelihood of success of the drone successfully finishing its flight route and completing its intended mission, at least as far as successful flying is concerned. Factors for that drone that may reveal rotor performance may include drone and/or rotor tilt, a flight path, rotational direction and speed of the rotors, physical damage, and an amount of free fall. The various structures described below are examples of the sensors 316, the navigation and control sensors 306, the positioning sensor 350, the camera 314, the microphone 318, and/or other components or structure that are depicted in FIG. 3.

A tilt angle of a drone may be measured by a gyroscope that is within or attached to the drone body. A tilt angle of a drone may alternatively or additionally be measured by a navigational satellite responder which triangulates navigational satellite signals such as GPS signals. A transceiver 312 that is attached to or within the drone body may receive a navigational signal, e.g., a GPS signal, from one or more satellites and perform computations on the signal to determine a location of the drone as well as a tilt of the drone.

An intended flight path may be saved in a computer memory storage of or connected to the drone on-board computer 220. A further drone control program within the drone on-board computer 220 may compare a current location of the drone, e.g., which current location is determined via navigational-satellite signal tracking and triangulation, to the stored intended flight path to ascertain whether the drone is along the flight path or has deviated from the flight path. For a deviation, the drone on-board computer 220 may determine an amount of deviation from the intended flight path.

An accelerometer that is attached to or within the drone body may measure a speed and/or acceleration of flight of the in-air drone. This speed and/or acceleration may be used to determine rotor health. An amount of power sent to the rotors may be measured via one or more sensors. An expected speed and/or expected acceleration may be determined based on the amount of power that is measured. The expected speed and/or the expected acceleration may be compared to the actual speed and/or the actual acceleration, respectively, that are measured by the accelerometer. Deviations of the measured speed or acceleration to the expected speed or acceleration, respectively, above a saved pre-determined threshold may indicate a structural problem such as a failing, struggling, or non-functioning rotor.

A camera 314 that is attached to the drone may also capture images, e.g., video images, which may be used to measure health of the rotor. The cameras may be indirectly attached to the drone main body by being attached to an arm of the drone. In one embodiment, a camera attached to an arm of the drone may capture images of that arm and/or of a neighboring arm. The camera may recognize structural faults in an arm such as a cavity, a rip, a nick, a crack, a crease, a bend, and/or a deformation, etc. The camera 314 may transmit image data to the drone on-board computer 220 via a wired or wireless connection. The drone on-board computer 220 may have stored therein a machine learning model for recognizing and classifying drone arm defaults based on images that are input. The machine learning model may be trained before flight in a supervised manner by having images and/or videos of other damaged arms being input and a corresponding overall health determination associated with the images and/or videos. This corresponding overall health determination may include output determinations such as damaged and should be detached, damaged but still functioning, etc. A drone such as the first drone 108 that is in flight may transmit image data via the communication network 116 to the computer 102 or to the server 112 so that the image data may be uploaded to a central version of the machine learning model that classifies images of drone arms and of damaged arms according to their health status. Drones that store a local instance of the machine learning model on their respective on-board computer may before flights receive updates from a central version of this machine learning model that classifies images of drone arms and drone arm damage. In some embodiments, the on-board drone cameras such as the camera 314 may be nano-cameras.

In some embodiments, cameras in an environment and connected to the computer 102 or to the server 112 via the communication network 116 which are not directly attached to the flying drone may capture images and/or video of the drone that is in-flight. The images from these external cameras may be input into the machine learning model for arm damage classification. The camera 314 in FIG. 3. may capture images and/or video to help sense rotor or arm health.

One or more microphones 318 that are attached to the drone or are within the drone may also capture audio recordings of a respective rotor rotating. The drone on-board computer 220 may also store another audio sound machine learning model which is similar and/or equivalent to the image-based machine learning model described above but uses audio as input and also makes classification determinations about rotor/arm health.

Measuring rotation speed of the individual rotors may be achieved by sensors disposed near, on, or adjacent the respective rotors. These sensors may include electromechanical gauges that take readings from drivetrain rotations. For example, magnetoresistive sensors may be in the drone and may recognize magnets disposed on a moving or stationary drone element via measuring the effect of the one or more magnets on an output voltage of a circuit. Additionally or alternatively Hall-effect sensors or inductive sensors may be used to determine a speed of rotation of a rotor. The measured rotational speed may be compared against an expected speed which is determined based off the measured amount of power being delivered to the rotor. A deviation of the actual rotational speed to the expected rotational speed may be understood by the on-board drone control program of the computer of the flying drone to be a sign of rotor malfunction.

Measuring a free fall of the in-flight drone may occur with the use of various sensors such as a speed sensor, an accelerometer, and/or a barometer. A speed sensor and/or an accelerometer may measure speed and/or acceleration in a downward direction. A barometer which is on or attached to the drone body may measure changes in pressure and may recognize that a large change in pressure may be indicative of a free fall. A change of these variables above a pre-determined threshold amount may reflect a free fall and a failing or struggling rotor and may be identified by the on-board drone control program of the computer of the flying drone.

In alternative embodiments, a LIDAR sensor which uses lasers and/or an acoustic sensor that uses acoustic waves, e.g., ultrasonic waves, may also be used to obtain information about the status of the rotors and/or arms and whether the arms have a defect.

In a step 506 of the in-flight drone structure modification process 500, a determination is made as to whether the sensor data indicates rotor problems or failure. This sensor data may be data that is captured by the drone sensors as part of step 504. This step 506 may include correlation of sensor data from multiple various sensors. A lack of data from a particular sensor may also be analyzed and may indicate wing/arm damage and/or rotor damage. If the determination is affirmative that the sensor data indicates the presence of rotor problems or rotor failure, the in-flight drone structure modification process 500 proceeds to step 510 of the in-flight drone structure modification process 500. If the determination is negative that the sensor data indicates no rotor problems or rotor failure, the in-flight drone structure modification process 500 proceeds to step 508 of the in-flight drone structure modification process 500.

One or more of the data sets from the various sensors described above and/or from additional sensors may be input into a drone arm health machine learning model. This drone arm health machine learning model receives various data sets or outputs from other machine learning models as input and then as output gives a health determination as output. The drone on-board computer 220 may have stored this arm health machine learning model for recognizing and classifying drone arm health. This machine learning model may be trained before flight in a supervised manner by having data sets and other model outputs be input with associated determinations (e.g., damaged, not damaged). A drone such as the first drone 108 that is in flight may transmit overall drone arm sensor data via the communication network 116 to the computer 102 or to the server 112 so that the sensor data may be uploaded into a central version of the arm health machine learning model that classifies health of drone arms based on a variety of sensor data received. Drones that store a local instance of the arm health machine learning model on their respective on-board computer may before flights receive updates from a central version of this arm health machine learning model that classifies health of drone arms.

An analysis may be performed in step 506 for all, some, or for one of the rotors of the in-flight drone. The step 506 may include a determination of which of the multiple rotors of the flying drone is experiencing any challenges.

In a step 508 (which may occur in response to a determination of no rotor problems in step 506) of the in-flight drone structure modification process 500, a determination is made as to whether the drone flight is finished. This drone flight may be the drone flight that was launched in step 502. This drone flight may be for the drone whose drone sensors provided data for the check in step 504. This sensor data may be data that is captured by the drone sensors as part of step 504. If the determination of step 508 is affirmative that the drone flight is finished, the in-flight drone structure modification process 500 may proceed to an end of the in-flight drone structure modification process 500. If the determination of step 508 is negative and the drone flight continues, the in-flight drone structure modification process 500 proceeds to step 504 of the in-flight drone structure modification process 500 for a repeat of at least steps 504 and 506 in the in-flight drone structure modification process 500.

In a step 510 (which may occur in response to a determination of one or more rotor problems in step 506) of the in-flight drone structure modification process 500, a determination is made as to whether a problematic rotor is causing more harm than help. This harm or help may relate to the effects that the rotor is having on the drone flight that was launched in step 502 and whose rotor health is being checked in step 504. The problematic rotor may be one that was identified in step 506.

If the determination of step 510 is affirmative that the problematic rotor is causing more harm than help, the in-flight drone structure modification process 500 may proceed to step 512 of the in-flight drone structure modification process 500. If the determination of step 510 is negative due to the problematic rotor causing more help than harm for the flight, the in-flight drone structure modification process 500 proceeds to step 508 of the in-flight drone structure modification process 500. Step 508 was described earlier.

Step 510 may include inputting one or more of the data sets from the various sensors described above and/or from one or more additional sensors and/or one or more outputs from the various machine learning models described above into a threshold arm damage machine learning model. Such outputs may include a machine learning model determination that a particular rotor is experiencing some struggles or failing. This threshold arm damage machine learning model may give as output a determination as to whether a flight would for this drone would be more effective if the struggling or failing rotor and the corresponding arm supporting this rotor were detached from the drone and if the remaining arms and rotors power the drone. Various arm usage scenarios may be saved in this machine learning model for simulations which may indicate whether arm detachment is recommended or not. The simulations may include expected flight outcomes and flight control that may be achieved when, after a detachment of one arm, the remaining arms work together to continue the flight. The simulations may include expected flight outcomes when the remaining arms are modified in their operation and/or position in order to compensate for the lost arms. For example, remaining arms may rotate with an increased speed. Remaining arms/rotors may be moved in their position to find a new equidistance from neighboring arms/rotors and so that a gap in rotor/arm positioning due to the detachment is filled. This threshold determination machine learning model may be trained before flight. A drone such as the first drone 108 that is in flight may transmit overall drone arm sensor data and machine learning outputs via the communication network 116 to the computer 102 or to the server 112 so that the sensor data and machine learning outputs may be uploaded into a central version of the threshold determination machine learning model that gives a drone arm detachment recommendation or a recommendation not to detach the arm. Drones that store a local instance of the threshold determination machine learning model on their respective on-board computer may before flights receive updates from a central version of this threshold determination machine learning model that gives a detachment recommendation or a recommendation not to detach.

In a step 512 (which may occur in response to a recommendation for detachment from step 510) of the in-flight drone structure modification process 500, a message is generated and transmitted asking for approval of arm detachment. This arm detachment may relate to an arm of the drone that was launched for flight in step 502 and whose rotor health was being checked in step 504. The message may be generated and transmitted via the drone on-board computer 220 and sent via the communication network 116 to the computer 102 and/or to the server 112. A notification of an urgent message may be given by the computer 102 when the message is received. A user at the computer 102 may actuate, e.g., click, a notification to see the message and to see the recommendation for a detachment of one or more of the arms of the rotor. The message may include a graphical user interface which allows a user to provide a response to the recommendation. For example, an acceptance box may be generated. Actuation of this acceptance box, e.g., via the user moving a cursor to the box and clicking on same or hitting an enter key on same, may cause a response message to be generated and transmitted that is sent back to the in-flight drone, e.g., to the first drone 108, to authorize an arm detachment.

In some embodiments, a graphical user interface may give an option to a user to choose between various modifications for the remaining arms to compensate for the detached arm. For example, the graphical user interface may present options of moving positions of the remaining arms, altering tilt angles of the remaining arms, and/or altering rotational speeds of the remaining arms for implementation for compensation for one or more of the arms being detached.

In some alternative embodiments, for step 512 a message would be generated that gives a user an option to choose between arm detachment or arm retraction for drone structure modification to alleviate affects of a failing drone arm/rotor. The arm retraction may include powering down of an extended arm and then lowering the arm within a main body of the drone or to escape a lateral periphery of the main body of the drone.

In some alternative embodiments, for step 512 the message may also include a proposed emergency landing plan. The user may be given an option to accept the proposed emergency landing plan.

The message generated and transmitted in step 512 may also be a general warning message indicating a problem with the drone flight, e.g., a problem with one or more of the arms/rotors of the drone. The message may also include an emergency landing plan for the drone.

Responses provided by a user at the computer 102 may be transmitted back to the flying drone and to the on-board drone computer 220 for implementation of instructions of the response.

In a step 514 of the in-flight drone structure modification process 500, a determination is made as to whether a response message authorizes arm detachment. The response message may be sent and received in response to a user receiving the message that was generated and transmitted in step 512. The in-flight drone, e.g., the first drone 108, may receive a response message that was generated from the response of the user after the user received and viewed the message of step 512. If the determination of step 514 is affirmative that the response message authorizes arm detachment, the in-flight drone structure modification process 500 may proceed to step 516 of the in-flight drone structure modification process 500. If the determination of step 514 is negative, the in-flight drone structure modification process 500 proceeds to step 508 of the in-flight drone structure modification process 500. Step 508 was described earlier.

In some embodiments, the drone and drone on-board computer 220 may be programmed as a default to perform the action recommended in the message of step 512 if no response message is received within a predetermined time, e.g., within thirty seconds of transmission of the first message or if the drone on-board computer 220 recognizes that a crash of the flying drone is imminent.

As part of the determination of step 514, the drone on-board computer 220 may include text and/or data analysis to determine the contents of the response message that is received.

In a step 516 of the in-flight drone structure modification process 500, an arm is detached as initiated by the drone computer. This detached arm may be that arm whose rotor was having troubles and causing more harm than help for the flight of the drone. The drone may include various structures to facilitate arm detachment. Examples of embodiments showing such arm detachment structures are shown in FIGS. 2 and 4B.

In a step 518 of the in-flight drone structure modification process 500, a parachute attached to the discharged arm is deployed. This arm may be the arm that was detached in step 516. A parachute such as the parachute 208 shown in FIG. 2 may be deployed after the arm is detached from the main drone body. A signal may be sent from the on-board drone computer 220 to the circuitry connected to the parachute 208 to cause the parachute to immediately deploy after detachment or to deploy after a predetermined time, e.g., three seconds after detachment, or to deploy after pre-determined threshold sensor values are met. The detached arm may contain its own sensors related to free fall, acceleration, and speed. A control signal to deploy the parachute 208 may be given when sensor data indicates that the detached arm is in a favorable and/or acceptable speed, position, and/or orientation for parachute deployment.

In a step 520 of the in-flight drone structure modification process 500, the remaining drone arms are modified to stabilize the drone flight. The remaining drone arms may be those that are attached to that drone that was launched for flight in step 502, whose rotors were analyzed for health in other steps of the in-flight drone structure modification process 500, and whose other arm was detached in step 516. The modifications of the remaining drone arm may include a change in position of the remaining arms, a change in tilt angle of the remaining arms, and/or a change in rotational direction and/or speed of the remaining arms/rotors. Remaining arms/rotors may be moved in their position to find a new equidistance or uniform distance from neighboring arms/rotors and so that a gap in rotor/arm positioning due to the detachment is filled. For example if six rotors were spaced equally around a periphery of the drone and one arm is detached, the remaining five rotors may be moved, e.g., via a movement of the support structure connected to these rotors, so that the five rotors are then spaced in an equidistant manner around the periphery of the drone. In one embodiment, the remaining arms may be moved along an arm track such as the arm track 404 shown in FIG. 4A for this compensation adjustment.

For drones with arms in a fixed position, the power to the remaining arms may be increased and/or otherwise adjusted to enhance drone flight operations. For example, if an arm at the back of the drone fails, then another back arm of the drone may be given more power to increase rotational speed of its rotor and to stabilize the drone.

The drone on-board computer 220 may calculate an optimum placement and/or rotational speed of the remaining wings and may include in the calculation an expected thrust generated by the remaining wings at different orientations and/or positions and/or rotational speeds. The placement and other modifications would be intended to achieve a slow and safe landing for the drone.

In a step 522 of the in-flight drone structure modification process 500, a flight plan is continued and the drone is safely landed or an emergency landing for the drone is performed. If the drone is near its initial liftoff or ending position, the landing plan may have the drone land at that same liftoff or ending position. The drone may also use sensor data to perform real-time object detection to make a landing plan for an area that is free of physical hazards. Thrust in each arm may be automated by leveraging autonomous flight technology. For a remotely piloted drone, the pilot may also use flying controls to guide the drone further and during the landing. If a remote pilot chooses a spot for landing which a further drone control program of the drone on-board computer 220 deems as hazardous, the drone on-board computer 220 may initiate autonomous control of the drone to perform the landing. If a remote pilot seems to be losing flight control of the drone as sensed by a drone control program of the drone on-board computer 220, the drone control program of the drone on-board computer 220 may initiate autonomous control of the drone to perform the landing. After landing, lights on the drone may flash or light to indicate which arm was broken and/or detached.

In some embodiments, the in-flight drone structure modification process 500 may also include a step of optimal modification of payload positioning to enhance safety of the payload being carried and/or transported by the flying drone. In some instances a payload may be carried underneath the drone while the drone flies, for example as would occur with the orientation of the payload harness 230 that is shown in FIG. 2. If the drone control programs senses impending danger for the drone such as an impending crash, the drone control program may use the sensor data and data about the content, size, and dimensions of the payload to cause the structure and/or drone to alter the position of the payload before the crash or collision occurs in order to provide enhanced protection for the payload against impact forces that may occur during a crash or collision. This payload position altering may also occur to alleviate reduced flying power or maneuverability that may occur after an arm detachment. Information about enhanced positioning for payload protection may be stored in the machine learning models. Past drone flight information for similar drones and other drones including past flight crashes and/or collisions and similar and other payloads and resulting payload damage may be used as training for the machine learning model before the flight of the current drone begins.

A payload control program in the drone on-board computer may determine an optimum positioning for the payload and may send control signals to the payload control structure of the drone to move the payload to this optimal position. For example, the payload control program may send signals to the drone on-board payload harness 230 and to an actuator for positioning the payload harness which cause the drone on-board payload harness 230 and the payload being carried to move in their positions with respect to the drone main body 202. This movement may move the payload harness 230 along a track to change a position from being underneath the drone main body 202 to being disposed on a lateral side or an upper side or into being disposed in an interior of the drone main body 202.

This payload position altering may occur alternatively or additionally by altering a lift power from the operating remaining arms of the drone to change the position/orientation of the drone in the air so that the payload thereby moves to a more protected position. For example, changing power sent to some of the rotors may cause the drone to dip or rotate forward so that payload being carried is shifted towards a backside of the drone instead of at a front and/or leading angle of the drone. This drone flight dip/rotation may occur in addition to or as an alternative to the payload harness being moved with respect to the drone main body, e.g., with the payload harness 230 moving along the done main body 202.

In some embodiments, the payload control program may cause an altering of a position of the remaining drone arms to move the payload into a more protected position. For example, certain of the remaining drone arms may be extended and others partially retracted so that a center of gravity of the drone is altered which alters the position of the payload being carried.

A trained machine learning model may also be stored in the drone on-board computer 220 to provide output recommendations for best positioning of a payload. The payload movement recommendations may also be based on optimal flying capabilities of the modified drone in addition to considerations based on protection of the payload.

In a step 524 of the in-flight drone structure modification process 500, the detached arm is tracked and located using an arm navigational signal. This detached arm may be that arm that was detached in step 516 and whose parachute was deployed in step 518. The detached arm may include a satellite navigational responder/transmitter 210 as shown in FIG. 2 which transmits a satellite navigational signal which allows detection from other devices with satellite navigational signal receivers. The detached arm may also include lighting, e.g., LED lighting, which may be triggered upon detachment or earth impact and which facilitate easier visual locating of the detached arm on the ground, in trees, in the water, etc. A flotation device attached to the arm may be generated upon impact of the drone on a body of water which will allow the arm to float until being tracked, located, and retrieved.

After step 524, the in-flight drone structure modification process 500 may proceed to an end.

The various machine learning models described above for steps 506, 510, 514, 520 and/or 522 may include naive Bayes models, random decision tree models, linear statistical query models, logistic regression n models, neural network models, e.g. convolutional neural networks, multi-layer perceptrons, residual networks, long short-term memory architectures, algorithms, deep learning models, and other models. The process of training a machine learning model may include providing training data to a learning algorithm or to a machine learning algorithm. The machine learning model is the model structure or system that is created by the training process. The training data should include targets or target attributes which include a correct answer. The learning algorithm finds patterns in the training data in order to map the input data attributes to the target. The machine learning model contains these patterns so that the answer can be predicted for similar future inputs. A machine learning model may be used to obtain predictions on new data for which the target is unknown. The machine learning model uses the patterns that are identified to determine what the target is for new data without a given answer. Training may include supervised and/or unsupervised learning.

Various commercial platforms exist to allow a machine learning model to be created or trained. The training may include selecting data types, uploading data, selecting class types, and allowing a commercial system to then train the data. Such data upload may occur at the computer 102 or at another computer associated with the server 112. The machine learning model that is generated may be stored on computer 102 or on the server 112 or on another external server accessible to the computer 102 and to the server 112 via the communication network 116. A local instance of the machine learning model may be stored on computer memory in a computer of a drone that is to undertake a flight. The automated learning may be performed via a machine learning model on the device or in the cloud. Using a machine learning model on the device helps reduce data transmission required between the device and a server in the cloud. Such a mobile machine learning model may be performed using inference-based machine learning models such as TensorFlow® Lite (TensorFlow® and all TensorFlow®—based trademarks and logos are trademarks or registered trademarks of Google, Inc. and/or its affiliates).

The machine learning model or models that are generated may be setup for receiving pictures of an object, audio recordings, and/or additional sensor data as input into the machine learning model and for generating, as output, determinations of rotor failure and/or recommendations of rotor detachment and recommendations for remaining arm placement and operation and for recommendations of payload positioning.

It may be appreciated that FIGS. 2-5 provide only illustrations of some embodiments and do not imply any limitations with regard to how different embodiments may be implemented. Many modifications to the depicted embodiment(s), e.g., to a depicted sequence of steps, may be made based on design and implementation requirements. Features of the various embodiments described may be combined with other embodiments or may replace features of other embodiments.

Users of the drone control program 110a, 110b and the above-described software may for some drones be able to integrate the software into existing drone systems, e.g., via a software update. Through opting in, this software module would have access to all of the information including the sensor data of the drone. The software module may be implemented for drones with autonomous flight capabilities but also for drones that are remotely operated by a remote pilot.

FIG. 6 is a block diagram 600 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 602a, 602b, 604a, 604b is representative of any electronic device capable of executing machine-readable program instructions. Data processing system 602a, 602b, 604a, 604b may be representative of a smart phone, a computer system, PDA, or other electronic devices. Examples of computing systems, environments, and/or configurations that may represented by data processing system 602a, 602b, 604a, 604b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102, server 112, an internal computer of a flying drone such as the first drone 108, and the drone on-board computer 220 may include respective sets of internal components 602a, 602b and external components 604a, 604b illustrated in FIG. 6. Each of the sets of internal components 602a, 602b includes one or more processors 606, one or more computer-readable RAMs 608 and one or more computer-readable ROMs 610 on one or more buses 612, and one or more operating systems 614 and one or more computer-readable tangible storage devices 616. The one or more operating systems 614 and the drone control program 110a in client computer 102, the drone control program 110b in server 112, and further drone control programs stored in the drone on-board computer 220, e.g., in a computer of the first drone 108 may be stored on one or more computer-readable tangible storage devices 616 for execution by one or more processors 606 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices 616 is a semiconductor storage device such as ROM 610, EPROM, flash memory, or any other computer-readable tangible storage device that can store a computer program and digital information.

Each set of internal components 602a, 602b also includes a RAY drive or interface 618 to read from and write to one or more portable computer-readable tangible storage devices 620 such as a CD-ROM, DVD, memory stick, magnetic tape, magnetic disk, optical disk or semiconductor storage device. A software program, such as the drone control program 110a, 110b, may be stored on one or more of the respective portable computer-readable tangible storage devices 620, read via the respective RAY drive or interface 618 and loaded into the respective hard drive 616.

Each set of internal components 602a, 602b may also include network adapters (or switch port cards) or interfaces 622 such as a TCP/IP adapter cards, wireless wi-fi interface cards, or 3G or 4G wireless interface cards or other wired or wireless communication links. The drone control program 110a in client computer 102, the drone control program 110b in the server 112, and a further drone control program in a computer of the first drone 108 or in the drone on-board computer 220 may be downloaded from an external computer (e.g., server) via a network (for example, the Internet, a local area network or other, wide area network) and respective network adapters or interfaces 622. From the network adapters (or switch port adaptors) or interfaces 622, the drone control program 110a in client computer 102, the drone control program 110b in server 112, and a further drone control program in drone on-board computer 220 and/or in a computer of the first drone 108 are loaded into the respective hard drive 616. The network may include copper wires, optical fibers, wireless transmission, routers, firewalls, switches, gateway computers and/or edge servers.

Each of the sets of external components 604a, 604b can include a computer display monitor 624, a keyboard 626, and a computer mouse 628. On the drones themselves, the external components may constitute a touch screen keyboard and/or a keyboard built into the drone main body, e.g., in a flush manner with an outer wall of the drone main body and/or a scroll pad built into the drone main body, e.g., in a flush manner with an outer wall of the drone main body. External components 604a, 604b can also include touch screens, virtual keyboards, touch pads, pointing devices, and other human interface devices. Each of the sets of internal components 602a, 602b also includes device drivers 630 to interface to computer display monitor 624, keyboard 626 and computer mouse 628. The device drivers 630, R/W drive or interface 618, and network adapter or interface 622 include hardware and software (stored in storage device 616 and/or ROM 610).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

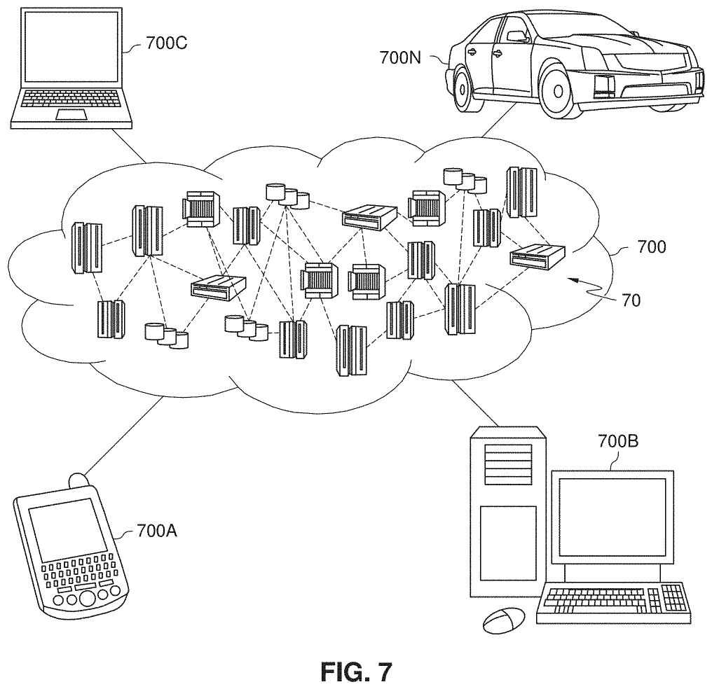

Referring now to FIG. 7, illustrative cloud computing environment 700 is depicted. As shown, cloud computing environment 700 comprises one or more cloud computing nodes 70 with which local computing devices used by cloud consumers, such as, for example, personal digital assistant (PDA) or cellular telephone 700A, desktop computer 700B, laptop computer 700C, and/or automobile computer system 700N may communicate. An on-board computer of a drone may constitute one of the nodes 70 of the cloud computing environment 700. Nodes 70 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 700A-N shown in FIG. 7 are intended to be illustrative only and that computing nodes 70 and cloud computing environment 700 can communicate with any type of computerized device over any type of network and/or network addressable connection (e.g., using a web browser).

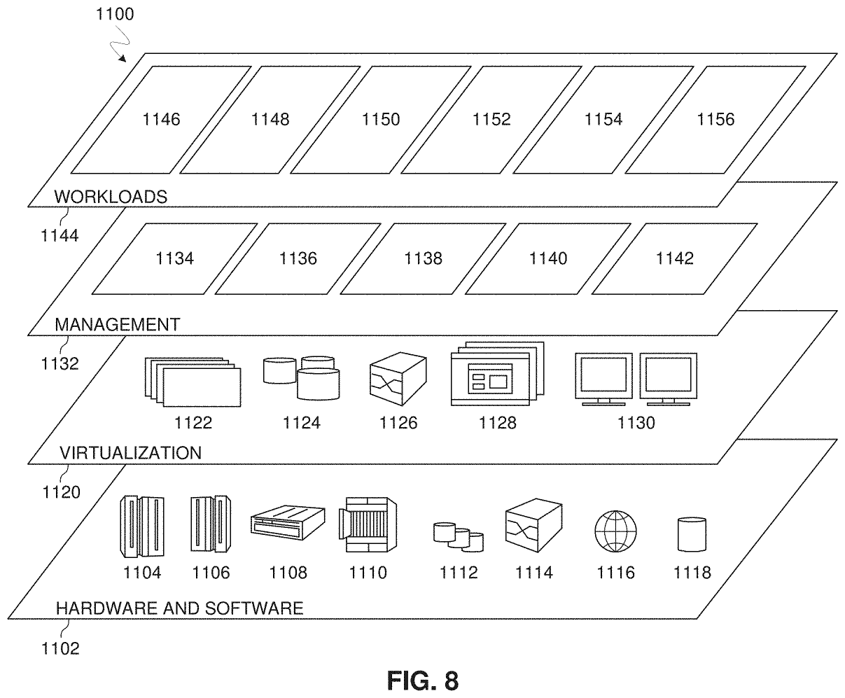

Referring now to FIG. 8, a set of functional abstraction layers 1100 provided by cloud computing environment 700 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and drone control/modification approval 1156. An in-flight drone structure modification process 500 provides a way for a user to authorize an in-flight drone modification, e.g., for the purposes of improving flight ability to allow a safe landing of a damaged drone and/or to finish a flight route for a damaged drone.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for mid-flight drone modification, the method comprising:
detecting, via a first sensor of a drone, damage to a first arm of the drone during a flight of the drone; and
in response to the detecting the damage, detaching, via a computer of the drone and during the flight of the drone, the damaged first arm of the drone.

2. The method of claim 1, further comprising modifying, during the flight and via the computer of the drone, remaining arms of the drone to compensate for the detached first arm such that the drone is able to finish the flight and safely land.

3. The method of claim 2, wherein the modifying comprises adjusting a position of the remaining arms.

4. The method of claim 2, wherein the modifying comprises adjusting one or more rotational speeds of the remaining arms.

5. The method of claim 1, wherein the first sensor is selected from a group consisting of a camera, a microphone, an accelerometer, a barometer, a satellite navigational signal responder, a gyroscope, a magnetoresistive sensor, a Hall-effect sensor, an inductive sensor, a LIDAR sensor, and an acoustic sensor.

6. The method of claim 1, further comprising deploying a parachute connected to the detached first arm.

7. The method of claim 1, wherein the drone is a multi-rotary drone.

8. The method of claim 1, further comprising, in response to detecting the damage, generating and transmitting from the drone a notification message.

9. The method of claim 1, further comprising emitting a navigational signal from the detached first arm.

10. The method of claim 1, further comprising:
determining, via the computer of the drone, another payload transport position for payload that is being transported via the drone; and
in response to the determining of the other payload transport position, moving the payload to the other payload transport position during the flight of the drone.

11. A computer system for mid-flight drone modification, the computer system comprising:
one or more processors, one or more computer-readable tangible storage media, and program instructions stored on at least one of the one or more computer-readable tangible storage media for execution by at least one of the one or more processors to cause the computer system to:
detect, from received sensor data, damage to a first arm of a drone during a flight of the drone; and
in response to the detecting the damage, transmitting detachment signals to cause the damaged first arm to be detached from the drone during the flight of the drone.

12. The computer system of claim 11, wherein the program instructions of the computer system are for further execution by the at least one of the one or more processors to further cause the computer system to modify, during the flight, remaining arms of the drone to compensate for the detached first arm such that the drone is able to finish the flight and safely land.

13. The computer system of claim 12, wherein the modifying comprises adjusting one or more rotational speeds of the remaining arms.

14. The computer system of claim 12, wherein the modifying comprises adjusting a position of the remaining arms with respect to a main body of the drone.

15. The computer system of claim 11, wherein the program instructions of the computer system are for further execution by the at least one of the one or more processors to further cause the computer system to generate and transmit from the drone a notification message, in response to detecting the damage.

16. A drone comprising:
a main body;
at least one power source connected to the main body; and
arms connected to the main body, each of the arms including a respective rotor which is drivable via the at least one power source, wherein the arms are detachable from the main body during a flight of the drone.

17. The drone of claim 16, further comprising an arm track in the main body, wherein the arms are engaged in the arm track to be movable around a periphery of the main body.

18. The drone of claim 16, further comprising a first sensor selected from a group consisting of a camera, a microphone, an accelerometer, a barometer, a satellite navigational signal responder, a gyroscope, a magnetoresistive sensor, a Hall-effect sensor, an inductive sensor, a LIDAR sensor, and an acoustic sensor;
wherein the first sensor is positioned to sense information regarding at least one of the arms.

19. The drone of claim 16, further comprising a parachute connected to at least one of the arms.

20. The drone of claim 16, further comprising a global navigational satellite signal transponder attached to at least one of the arms.
